(19) United States
(12) Patent Application Publication
(10) Pub. No.: US 2013/0087532 A1
(43) Pub. Date: Apr. 11, 2013

(54) SELF SECURING BRAZING PREFORM CLIP

(71) Applicants: Ronald D. Gentry, Cicero, IN (US); David C. Schuster, Indianapolis, IN (US)

(72) Inventors: Ronald D. Gentry, Cicero, IN (US); David C. Schuster, Indianapolis, IN (US)

(21) Appl. No.: 13/269,267

(22) Filed: Oct. 7, 2011

(51) Int. Cl. H05B 3/02; H02K 3/12

(52) U.S. Cl. 219/85.22; 310/71

(57) ABSTRACT

An apparatus for and a method of brazing copper armature conductors to a commutator during the production of automotive starting motors. In the inventive method, two conductors of the armature are brazed together and are also brazed to the corresponding slot in a commutator in a single step. The process is aided by an inventive brazing clip which includes a cleat or inwardly bent tab that engages the conductor of an armature to hold it in place.

### BACKGROUND

The present invention relates to the brazing of copper armature conductors to a commutator during the production of automotive starting motors.

Automotive starting motors are typically DC machines including a field winding on the stator, an armature winding on the rotor and a mechanical rectifier known as a commutator. The stator comprises a laminated ferromagnetic material equipped with protrusions around which the coils of the field winding are wrapped. The rotor includes a laminated core which is slotted to accommodate the armature winding. The armature winding is comprised of a plurality of copper armature conductors wound on the slots of the rotor. The commutator is a mechanical rectifier comprised of a plurality of parallel copper segments insulated from one another and arranged in cylindrical fashion. Carbon brushes ride on the commutator and serve to conduct direct current to the armature winding.

In production of an automotive starting motor, the copper armature conductors must be joined to the copper segments of the commutator to provide a connection between the armature winding and the commutator. In one known process, the copper armature conductors are typically joined to the commutator using a process of welding commonly referred to as “hot staking.” Hot staking involves applying a current through the armature conductors and a corresponding slot in the commutator, which generates heat. This is done by a pair of electrodes, one of which is positioned above and applies downward pressure onto the two armature conductors that are to be welded together and welded to a corresponding slot in the commutator. The combination of the heat and force softens the copper armature conductors and causes them to deform. After a period of time, current to the electrode is terminated and the electrode is removed. Thereafter, the copper conductors re-harden and form a bond with the walls of the slot in the commutator. The armature is then rotated to allow the hot staking machine to weld the next set of conductors in the respective slot of the commutator.

Unfortunately, in a hot staking operation, it is difficult to keep the tungsten electrode at a constant temperature. Instead, the electrode typically becomes hotter with each successive weld due to the same current being provided through the electrode during each weld and not much time being provided for cooling between welds. After several welds, the very hot electrode can cause damage by penetrating too far into the slot of the commutator when it contacts a conductor and causing the conductor to completely deform and melt into a U-shape around the electrode. These welds are faulty and are not capable of conducting current within an operating armature.

Brazing is another technique that can be used to electrically connect the conductor pairs of the armature and the corresponding slots in the commutator. In a brazing operation, a filler material is positioned in the location where the conductors are to be joined and heat is generated by a current provided by electrodes as in a hot staking application. As the temperature increases, the filler material begins to melt, which typically happens at a temperature at least 500° F. lower than the temperature at which the copper conductors begin to deform. As the filler material melts, it flows between the two conductors desired to be joined by capillary action.

In a typical brazing operation for conductors of an armature and commutator, a thin, flat brazing ribbon is placed between the faying surfaces of the conductors and the electrode then applies pressure and a current. After the brazing material melts, the remaining ribbon is withdrawn by hand. This process can be completed separately for the connection between the two conductors of the armature and then for the connection between the bottom armature conductor and the commutator slot. The armature can then be rotated and the brazing process repeated on the next set of conductors.

In contrast to hot staking, brazing advantageously avoids the problem of excessive heat causing the conductors to deform. That is, since the conductors that are joined are not melted in the brazing process, they retain their original shape, and edges and contours are not eroded or changed by the formation of a fillet. Further, since less heat is required to heat the brazing material to its melting temperature, the brazing process is more efficient than hot staking.

In a brazing operation, the brazing material must be carefully positioned and held in place at the conductors until the commutator is joined to the armature and the brazing process is completed. Inserting the brazing ribbon is typically done manually, which is inefficient and also requires two separate brazing steps, as discussed above. Further, it requires the fingers of the operator to be placed undesirably close to the electrodes, which press down onto the conductors with a rather large force of around 500 pounds. Brazing clips can be fitted on the armature conductors. Undesirably, however, it has been found that such clips can move from their proper position on the armature conductors when the commutator is joined to the armature.

### SUMMARY OF THE INVENTION

The present invention provides an apparatus for and a method of brazing copper armature conductors to a commutator during the production of automotive starting motors. In the inventive method, two conductors of the armature are brazed together and are also brazed to the corresponding slot in a commutator in a single step. The process is aided by an inventive brazing clip which includes a cleat or inwardly bent tab that engages the conductor of an armature to hold it in place.

In one form thereof, the present invention provides a method of brazing a pair of armature conductors and a commutator conductor. In this inventive method, an armature having a conductor pair comprising two spaced conductors is provided and a commutator having a commutator conductor is also provided. A brazing material is formed into a brazing clip configured to fit onto one conductor of the conductor pair of the armature, typically the lower conductor that is adjacent the commutator slot. A cleat is formed in the brazing clip and the clip is slid over the one conductor. The commutator is joined to the armature so that the commutator conductor is aligned with the conductor pair of the armature while the cleat prevents longitudinal movement of the brazing clip relative to the one conductor. A current is applied to the armature and thereby brazes together the pair of armature conductors and the commutator conductor.

Advantageously, the inventive method allows the brazing clips to be installed onto the armature conductors all at once, yet the clips need not be repositioned after the commutator is installed. This allows the process to be automated and avoids the need for an operator to place his or her hands near the conductors when the electrode is being applied.

In exemplary embodiments, the cleat is pointed and sharp. This allows the cleat to pierce the surface of the conductor and thereby “dig in” to the copper conductor and prevent longitudinal movement along the conductor of the armature. Similarly, the cleat or inwardly bent tab may also be positioned in an indentation previously formed in the conductor to thereby resist longitudinal movement of the brazing clip on the conductor by engagement of the cleat with the sidewalls of the indentation. The cleat or inwardly bent tab may also biasingly engage the conductor to thereby increase the bearing pressure exerted between the brazing clip and the conductor on the side of the conductor opposite the cleat to thereby resist longitudinal movement of the brazing clip on the conductor by frictional forces.

In accordance with these teachings, the brazing material is formed into a clip whose shape substantially conforms to the outer periphery of the armature conductor. The cleat or tab can be formed as a bent corner of the brazing clip. The number of cleats to be provided is a design variable. Since there are typically four corners on the material that is used to form the clip, there can be four cleats formed from the corners. Other variations are possible within the scope of these teachings.

In another form thereof, an exemplary apparatus for connecting an armature conductor pair and a conductive slot of a commutator is provided. The apparatus comprises a brazing clip shaped to conform to and fit over a conductor of an armature. The brazing clip has two edges that are spaced apart to define an open channel extending along the lengthwise direction of the clip. At least one of the edges terminates in a bent corner section, the bent corner section comprising a cleat configured to engage the conductor of the armature and prevent movement of the clip along a longitudinal axis of the armature conductor.

In certain embodiments, the armature conductor on which the brazing clip is placed has a cross-sectional profile that corresponds to the shape of the brazing clip. Optionally, the armature conductor may include an indentation which the cleat engages, which holds the brazing clip in place relative to the armature conductor. In other embodiments, the brazing clip can include two or more cleats.

### BRIEF DESCRIPTION OF THE DRAWINGS

The above-mentioned aspects of the present invention and the manner of obtaining them will become more apparent and the invention itself will be better understood by reference to the following description of the embodiments of the invention, taken in conjunction with the accompanying drawings, wherein:

FIG. 1 is an exploded perspective view showing an armature with a commutator and inventive brazing clips;

FIG. 2 is a perspective view of the components shown in FIG. 1 assembled together but before a brazing operation;

FIG. 2A is an enlarged perspective view of the section shown in FIG. 2 before a brazing operation;

FIG. 2B is an enlarged perspective view of the section shown in FIG. 2 after a brazing operation;

FIGS. 3A-3C are fragmentary perspective views showing an inventive clip of the present invention being installed on an armature conductor and an armature thereafter being mated with a commutator;

FIGS. 4A-4C show various embodiments of the inventive brazing clip before it is formed into it final shape for installation;

FIGS. 5A-5D show various geometries of the inventive brazing clip; and

FIGS. 6A-6C depicts a process for making brazing clips in accordance with the present invention.

Corresponding reference numerals are used to indicate corresponding parts throughout the several views.

### DETAILED DESCRIPTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

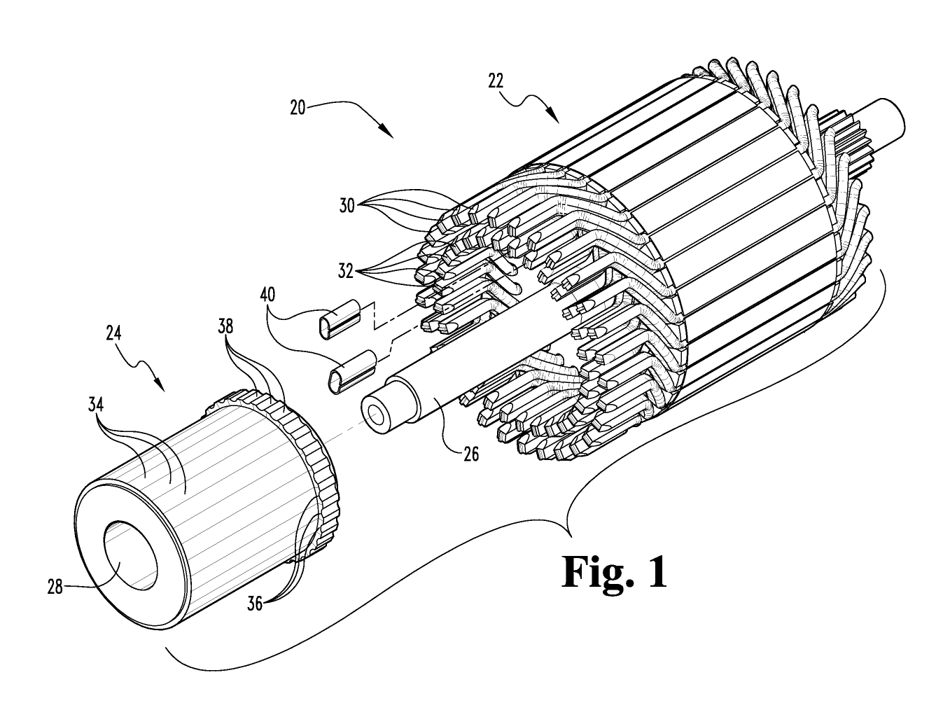

Turning now to FIG. 1, one embodiment of a device 20 is shown having an armature 22 to which a commutator 24 may connect by means of cylindrical shaft 26 that frictionally fits into cylindrical bore 28. Armature 22 includes a series of first conductors 30 extending outwardly from the armature body and these conductors 30 collectively form an outer circular periphery of conductors 30. A second series of conductors 32 also extend outwardly from the armature body and collectively form an inner circular periphery of conductors 32.

Commutator 24 has a series of parallel conductive segments 34 typically formed from copper which extend in the longitudinal direction of the commutator 24 and terminate in a series of risers 36 which define slots 38, which are also typically formed of copper. Advantageously, the height of the risers 36 can be less than is needed for a hot staking process. The windings of the armature comprise a plurality of conductor pairs each having a conductor 30 and a conductor 32, and each conductor pair 30, 32 is electrically connected to a corresponding slot 38 of the commutator 24. The conductors 30 and 32 are also typically formed of copper.

In embodiments in accordance with these teachings, the electrical connection between the conductors 30 and 32 of the armature conductor pairs and the corresponding slot 38 in the commutator 24 is made via brazing. A brazing material is provided in the form of a brazing clip 40, two of which are shown in FIG. 1 and the inventive details of which are described in more detail below.

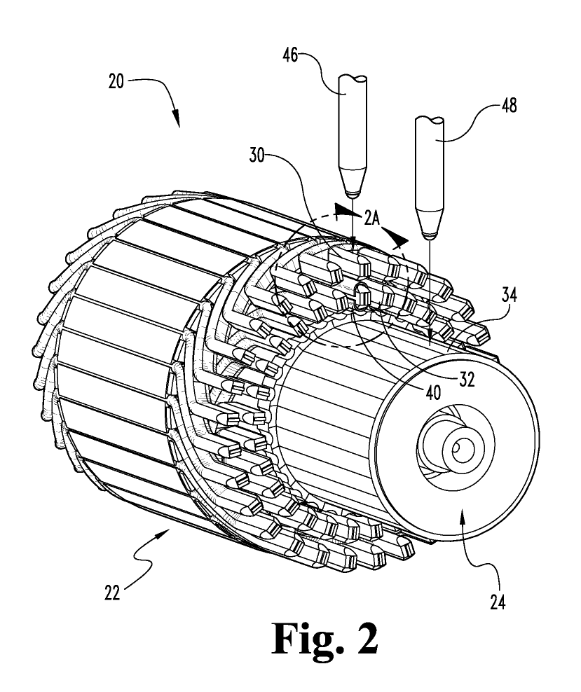

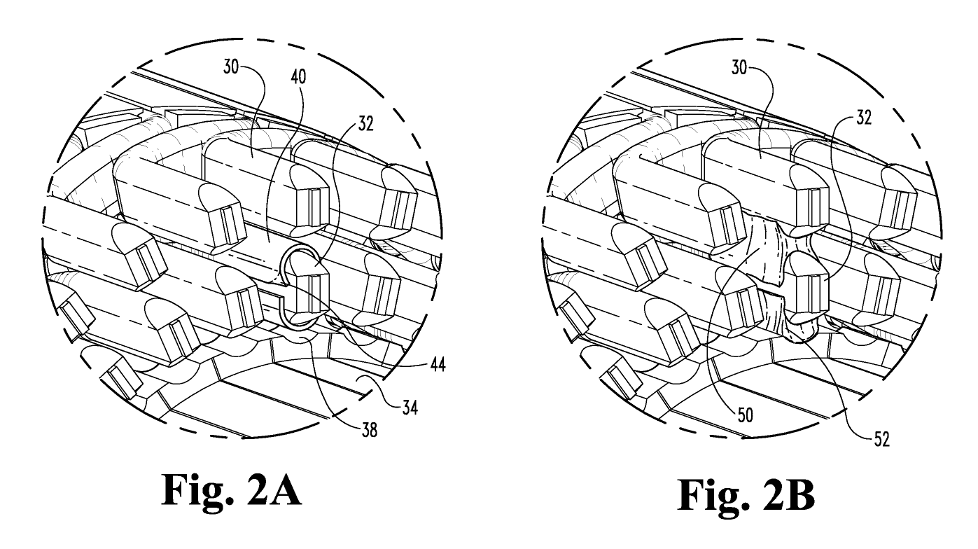

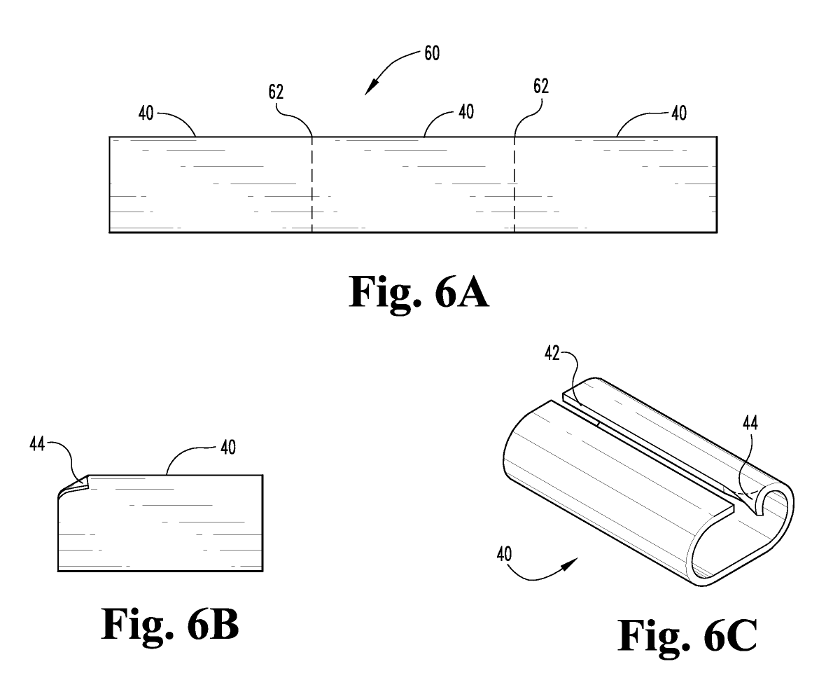

FIGS. 2 and 2A depict the device 20 with the commutator 24 assembled to the armature 24. As shown in more detail in FIGS. 2A and 6A, clip 40 is made of a thin brazing material, typically formed from an alloy of copper, phosphorus and silver. There are a large number of commercially available brazing alloys that may be suitable for use with the present invention, and one suitable alloy is known by those skilled in the art as BCuP 5, which has a composition of about 15% silver, 5% phosphorous, 80% copper and trace amounts of other materials.

Clip 40 has two edges that define an open channel or slot 42 extending along its lengthwise direction. In the embodiment shown in FIGS. 2A and 6, one of the edges of the clip terminates in a bent corner section, or “cleat” 44 which is also referred to herein as an inwardly bent tab. The inventive cleat 44 prevents the clip from moving on the conductor 32 when the commutator is assembled to the armature, as explained below.

FIGS. 2 and 2A show the armature, conductors 30, 32, slot 38 and clip 40 before the brazing operation is completed. To conduct the brazing operation, a copper electrode 46 (only a working portion of which is shown) is positioned over a conductor 30 in a location over one of the slots 38 and the electrode 46 is moved downward into contact with the conductor 30, applying force to the conductors. Electrode 48 (only a working portion of which is shown) is brought into contact with segment 34 of commutator 24 to complete the electrical circuit. The brazing material is typically positioned in the electrical circuit at two locations, between conductors 30 and 32 and between conductor 32 and commutator slot 38. In the illustrated embodiments, a single brazing clip 40 substantially surrounds conductor 32 and provides the brazing material for both of these two locations in the electrical circuit.

As force is applied to the conductors from the electrode 46, a voltage is applied across the electrodes 46 and 48, causing a current to flow through the conductors 30, 32, clip 40 and slot 38. The brazing current can be typically around 10,000 amps, which is applied for about 1 second or less, which typically produces sufficient heat to melt the brazing material. The electric current causes the copper conductors and clip to heat up. The clip 40 has a melting temperature of about 1420° F., whereas the copper conductors and slots have a higher melting temperature of about 2000° F., such that only the brazing material liquefies during the brazing operation. As the brazing material liquefies, the phosphorous component cleans the copper and the brazing alloy flows by capillary action into the spaces between the conductors 30 and 32 and between conductor 32 and slot 38.

After a period of time, the current is terminated. The downward force applied by the electrode, which can be about 500 lbs., is maintained for a time after the current is terminated. Thereafter, the electrodes are removed and the brazing material hardens and forms a bond with conductors 30 and 32 and with the slot 38. As shown in FIG. 2B, the brazing operation results in clip 40 forming two secure joints 50 and 52 which electrically connect conductors 30 and 32 and slot 38. After the brazing of one pair of conductors 30, 32 and a slot 38 is completed, the armature is rotated to allow the same brazing operation just described to take place on the next pair of conductors and associated slot of the commutator. This process is continued until all of the conductors are brazed.

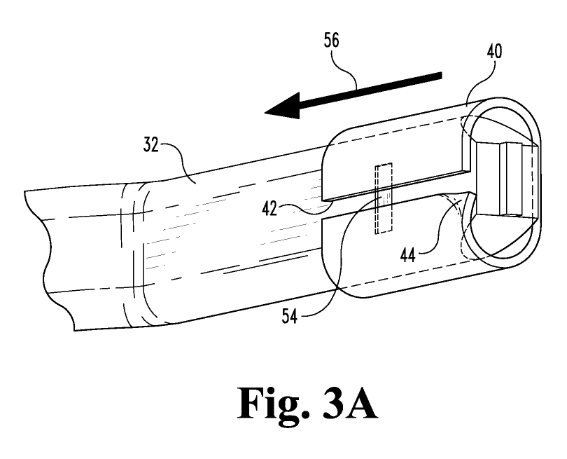

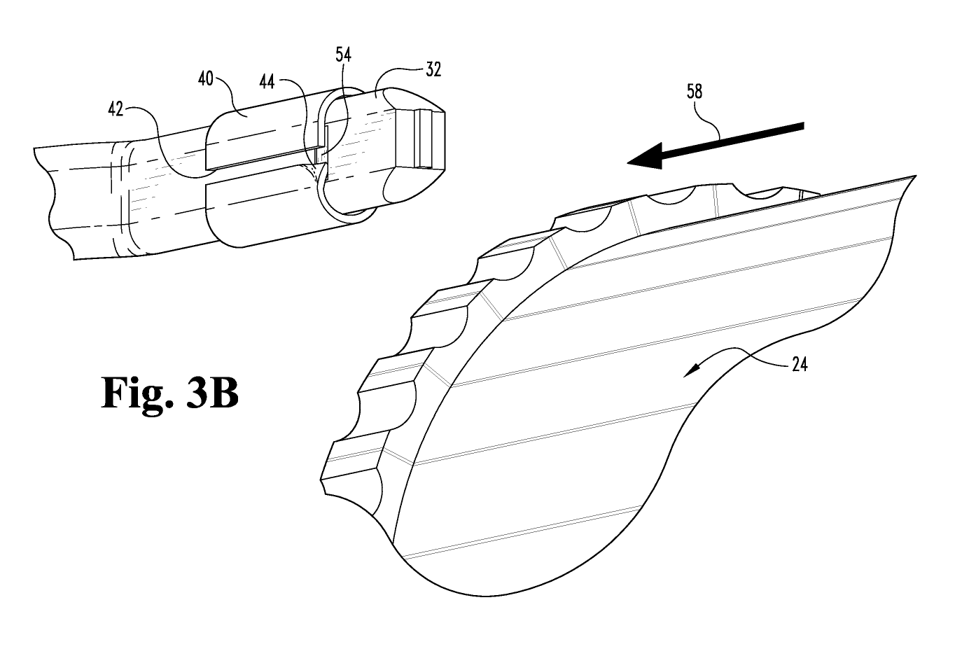

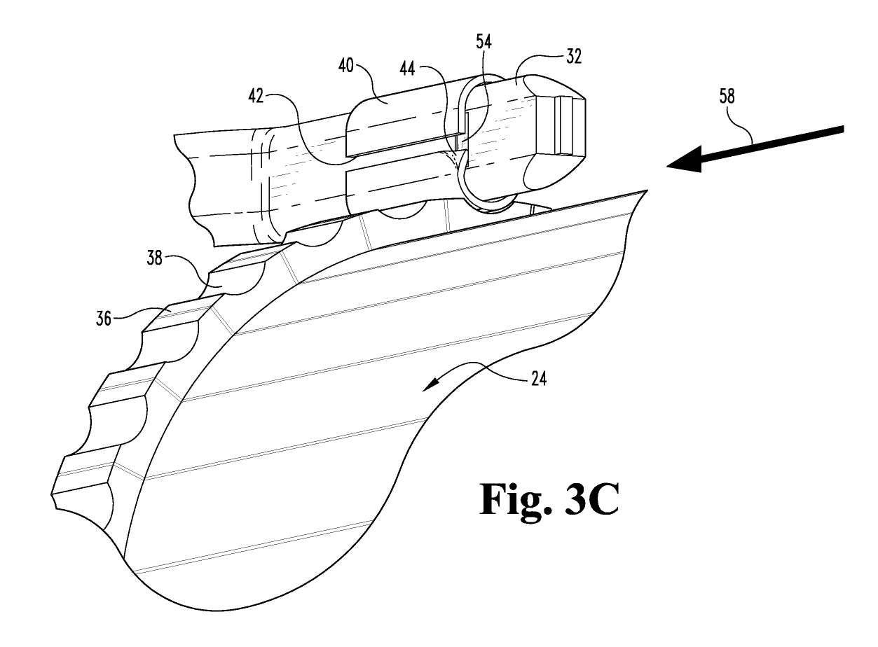

The role of the inventive brazing clip in the operation just described can be better understood with reference to FIG. 3, which shows a portion of a conductor 32 with a brazing clip 40 installed in the desired position for brazing. While many manufacturing steps can be conducted in various orders, in one embodiment of the assembly protocol of device 20, the clips 40 are placed onto all of the conductors 32 in the desired locations, after which the commutator is placed onto shaft 26 (FIG. 1) and moved into the proper position with respect to armature 22.

With reference to FIG. 3A, clip 40 is moved along the longitudinal axis of conductor 32, i.e., in the direction of arrow 56. As this is done, the cleat 44 frictionally engages the conductor 32. Turning to FIG. 3B, the clip 40 is shown in its final position, at which the cleat 44 engages an optional rectangular indentation 54 formed in conductor 32. The optional indentation 54 provides an additional means that complements the cleat 44 and assists securing the clip 44 in its final position. That is, the sidewalls of the rectangular indentation 54 tend to block the pointed cleat 44 and thereby prevent the clip 40 from sliding in a longitudinal direction along the conductor 32.

Preventing the longitudinal movement of clip 40, i.e., movement in the direction of arrow 56, is critically important during the installation of the commutator 24 to the armature 22. As depicted in FIGS. 3B and 3C, commutator 24 moves along the direction of arrow 58 until it reaches the position depicted in FIG. 3C. In prior art assembly processes, before the commutator is moved to its final position, the slots 38 or portions of the risers 36 often contact the clips 40 and undesirably move the latter out of their proper position for brazing. When this happens, a process that could otherwise be mostly automated requires manual intervention during which an operator must reposition the clips by hand in their proper position for brazing. This manual step slows the overall assembly process, adds unpredictability and inconsistency, and thus drives up the cost of assembly.

By contrast, embodiments incorporating brazing clips 40 with the inventive cleats 44 greatly reduce and can eliminate the problem of the brazing clip moving from their installation position during assembly of the commutator to the armature or at other times during the assembly process of the motor. In some embodiments, this is achieved with pointed cleats 44, so-named due to their functional resemblance to a cleat on an athletic shoe. The cleats “dig in” to the relatively soft copper and provide an engagement therewith that largely prevents movement of the brazing clip when minor contact, e.g., from the commutator, is made during the assembly process. In other embodiments, the cleats or inwardly bent tabs 44 may have a blunt distal end. Such blunted cleats could be positioned in indentations 54 to resist longitudinal movement. Alternatively, such blunted cleats could biasingly engage the conductor to increase the bearing pressure between the conductor and those portions of the brazing clip in contact with the conductor to thereby frictionally resist longitudinal movement of the brazing clip on the conductor. These different means for resisting longitudinal movement of the brazing clip may be employed singlely or be combined in any number of different combinations. For example, a pointed cleat could pierce the surface of the conductor, be located within a preformed indentation in the conductor and exert a biasing force against the conductor.

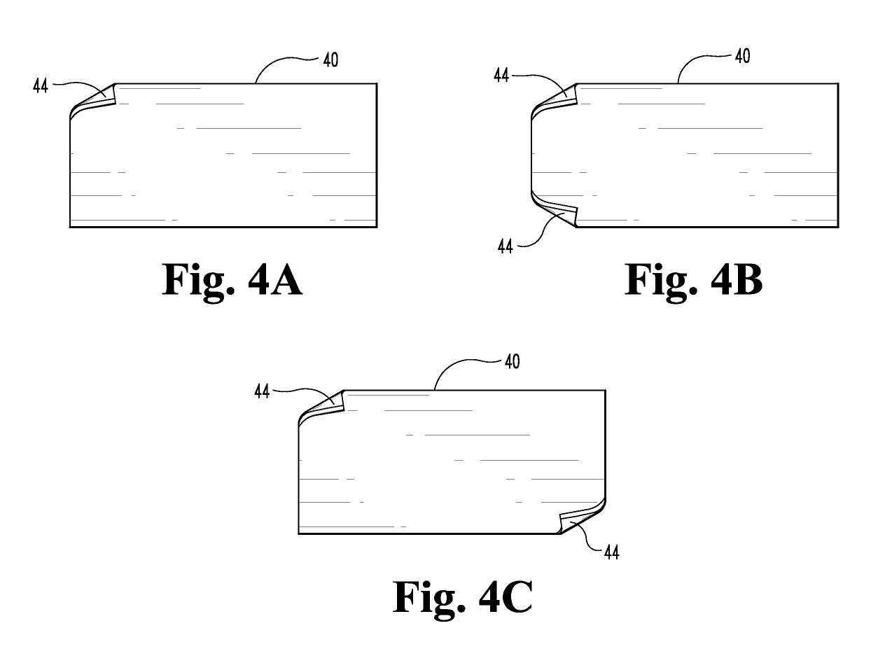

Configurations of the inventive clip other than the embodiment illustrated above are possible. For example, as already noted, in certain embodiments it may be desirable to form a depression on the conductors, such as depression 54, to assist the clip in remaining in its installation position. In other embodiments, a clip having a single cleat 44 in the form of a bent corner may be sufficient. FIGS. 4A-4C shows three embodiments of clips 40 before they are formed into the shape to fit over the conductors. In FIG. 4A, a clip 40 is shown having a single cleat 40. FIG. 4B illustrates an option in which two cleats are provided, one on the front longitudinal end of the clip and the other in the back. FIG. 4C shows a clip having two cleats, front and back and opposite sides. One of skill in the art would recognize other configurations within the scope of these teachings.

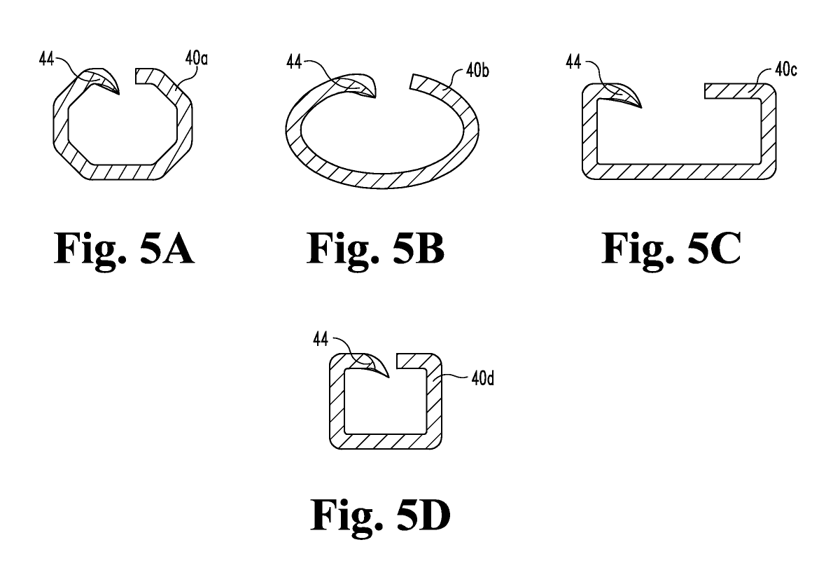

Advantageously, the inventive clips with cleats provided by these teachings are not limited to use with any specifically shaped brazing clip. Rather, the clips can be formed in any of a wide variety of shapes and still be formed with the inventive cleats. For example, FIG. 5A shows a clip 44a having a polygonal shape; FIG. 5B show a clip 44b having an oval shape; FIG. 5C shows a clip having a rectangular shape; and FIG. 5D shows a square shaped clip. One of skill in the art would recognize other clip geometries that could employ the inventive cleats, depending upon the cross-sectional shape of the conductors on which they are to be installed as well as other parameters.

Further, any of the wide variety of clip geometries contemplated by these teachings can be formed in a straightforward manner, as illustrated in FIGS. 6A-6C. Generally, a long “ribbon” 60 of brazing material is provided (e.g., in the form of a roll weighing 2 lbs.) and can be cut along dashed lines 62 to form flat pieces cut to the length needed to form clips 40. After the cutting process, the cleat 44 may be formed as shown in FIG. 6B and the material is then shaped into the final form of the clip 40 shown in FIG. 6C.

One of skill in the art would readily recognize a variety of methods for cutting the ribbon and shaping it into the final clip product. For example, the initial cutting along dashed lines 62 can be performed by a small tin snips instrument, or they can be punch cut in an automated or semi-automated fashion. The forming of the cleat can be done by a small needle-nose pliers or similar instrument, as can be the shaping into the final form of the clip. The ribbon material can also be placed over a form having the desired shape of the clip to shape the clip into its final form. Numerous other tools and methods for forming the inventive clips are possible within the scope of these teachings.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

1. A method of brazing a pair of armature conductors and a commutator conductor, comprising:
providing an armature having a conductor pair comprising two spaced conductors;
providing a commutator having a commutator conductor;
providing a brazing material and forming the brazing material into a brazing clip configured to fit onto one conductor of the conductor pair;
forming a cleat in the brazing clip;
sliding the brazing clip over the one conductor and engaging the one conductor with the cleat;
aligning the commutator conductor with the conductor pair of the armature while the cleat prevents longitudinal movement of the brazing clip relative to the one conductor; and
applying a current to the armature and thereby brazing together the pair of armature conductors and the commutator conductor.

2. The method of claim 1, wherein the step of forming a cleat comprises forming a pointed cleat.

3. The method of claim 2, wherein the pointed cleat is sharp.

4. The method of claim 1, wherein the cleat comprises a bent corner of the brazing clip.

5. The method of claim 1, further comprising forming the brazing material in a clip whose shape substantially conforms to the outer periphery of the one conductor.

6. The method of claim 1, wherein the two spaced conductors are oriented substantially parallel to one another.

7. The method of claim 1, further comprising forming a plurality of cleats on the brazing clip.

8. The method of claim 7, wherein each cleat comprises a bent corner of the brazing clip.

9. The method of claim 1, wherein the conductor pair of the armature comprises a plurality of conductor pairs, the commutator conductor comprises a plurality of commutator conductors, and the brazing clip comprises a plurality of brazing clips, the method further comprising aligning the commutator conductor with the armature while the cleat of each brazing clip prevents longitudinal movement of each brazing clip relative to respective conductors of the armature.

10. The method of claim 1 further comprising the step of providing the one conductor with an indentation and wherein the cleat is positioned in the indentation to thereby longitudinally secure the brazing clip to the one conductor.

11. A method of brazing a pair of armature conductors and a commutator conductor, comprising:
providing an armature having a conductor pair comprising two spaced conductors;
providing a commutator having a commutator conductor;
providing a brazing material and forming the brazing material into a brazing clip configured to substantially surround one conductor of the conductor pair;
forming an inwardly extending tab in the brazing clip;
longitudinally sliding the brazing clip onto the one conductor;
longitudinally securing the brazing clip relative to the conductor with the inwardly bent tab;
aligning the commutator conductor with the conductor pair of the armature; and
applying a current to the armature and thereby brazing together the pair of armature conductors and the commutator conductor.

12. The method of claim 11 wherein the inwardly bent tab biasingly engages the one conductor to thereby secure the brazing clip to the one conductor by frictional engagement of the clip with the one conductor.

13. The method of claim 11 wherein the inwardly bent tab includes a pointed tip and the pointed tip projects through a surface of the one electrode to thereby secure the brazing clip on the one conductor.

14. The method of claim 11 further comprising the step of providing the one conductor with an indentation and wherein the inwardly bent tab is positioned in the indentation to thereby longitudinally secure the brazing clip to the one conductor.

15. The method of claim 11 further comprising the step of forming the inwardly bent tab on the brazing clip by bending a corner of the brazing clip.

16. The method of claim 11 wherein the conductor pair of the armature comprises a plurality of conductor pairs, the commutator conductor comprises a plurality of commutator conductors, and the brazing clip comprises a plurality of brazing clips each having an inwardly bent tab and wherein the method includes first mounting each of the plurality of brazing clips on a respective one of the conductors of each of the plurality of conductor pairs and longitudinally securing each of the brazing clips by engaging each of the inwardly bent tabs with the respective one conductor and, after longitudinally securing each of the brazing clips, applying a current to the armature for each pair of armature conductors and associated commutator conductor to thereby braze together each pair of armature conductors and an associated one of the commutator conductors.

17. Apparatus for connecting an armature conductor pair and a conductive slot of a commutator, comprising a brazing clip shaped to conform to and fit over a conductor of an armature, the brazing clip having two edges that define an open channel extending along the lengthwise direction of the clip, at least one of the edges terminating in a bent corner section, the bent corner section comprising a cleat configured to engage the conductor of the armature and prevent movement of the clip along a longitudinal axis of the conductor.

18. The apparatus of claim 17, further comprising an armature conductor on which the brazing clip is placed, the armature conductor having a cross-sectional profile that corresponds to the shape of the brazing clip.

19. The apparatus of claim 18, wherein the armature conductor comprises an indentation which engages the cleat and thereby holds the brazing clip in place relative to the armature conductor.

20. The apparatus of claim 17, wherein the brazing clip comprises at least two cleats.
